(19) United States
(12) Patent Application Publication
(10) Pub. No.: US 2021/0362173 A1
(43) Pub. Date: Nov. 25, 2021

(54) LIQUID SPRAYING STRUCTURE WITH MAGNETIZATION DEVICE

(71) Applicant: Chin-Ming HSIEH, HSINCHU CITY (TW)

(72) Inventor: Chin-Ming HSIEH, HSINCHU CITY (TW)

(21) Appl. No.: 16/878,579

(22) Filed: May 19, 2020

(51) Int. Cl. B05B 5/035; B05B 1/34

(52) U.S. Cl. CPC B05B 5/035; B05B 1/34

(57) ABSTRACT

A liquid spraying structure with a magnetization device includes: a body having a through hole and a magnetic member accommodating portion around the through hole, the magnetic member accommodating portion having at least two magnetic member accommodating grooves; a plurality of magnetic members disposed in the at least two magnetic member accommodating grooves; a pump unit penetrating through the through hole and being used to draw liquid out of a bottle; and a spray head connected to one end of the pump unit, and the pump unit is used to transport the liquid in the bottle to the spray head.

### BACKGROUND

### Field of the Invention

The present invention relates to a liquid spraying structure, and more particularly to a liquid spraying structure with a magnetization device.

### Related Prior Art

The general spraying structure, such as the spray head, is widely used. It can be used in various occasions to spray the liquid in the form of mist and spread it well on the object to be sprayed. Take the bottle of the skin care product as an example, it is used to contain cosmetics, and the user presses the spray head of the bottle, so that the liquid skin care product is sprayed to the user's skin in a mist state. The aforementioned bottle and spray head are all known technologies in the technical field, so further explanation would be unnecessary.

The skin care industry has long been committed to miniaturizing the molecules of cosmetic liquids to improve the efficiency of skin absorption of skin care products. However, there are still considerable technical limitations. Therefore, there is an urgent need for a liquid spray structure that can separate the liquid molecules of the skin care product into a smaller number of molecular groups, thereby improving the absorption effect of the skin.

The present invention has arisen to mitigate and/or obviate the afore-described disadvantages.

### SUMMARY

One objective of the present invention is to provide a liquid spraying structure with a magnetization device, which can make the liquid molecules fine after the liquid passes through the liquid spraying structure, so as to enhance the practicality.

To achieve the above objective, a liquid spraying structure with a magnetization device comprises:

a body having a through hole and a magnetic member accommodating portion around the through hole, the magnetic member accommodating portion having at least two magnetic member accommodating grooves;

a plurality of magnetic members disposed in the at least two magnetic member accommodating grooves;

a pump unit penetrating through the through hole and being used to draw liquid out of a bottle; and

a spray head connected to one end of the pump unit, and the pump unit is used to transport the liquid in the bottle to the spray head.

As can be seen from the foregoing, the magnetic member accommodating grooves are provided in the body to accommodate the magnetic members, so that the magnetic members are fixed around the pump unit to let the magnetic force affect the liquid passing through the pump unit, and thus making the molecules of the liquid finer, and improving practicality.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an exploded view of one embodiment of the liquid spraying structure with a magnetization device;

FIG. 2 is a partial cross-sectional view of one embodiment of a liquid spraying structure with a magnetization device;

FIG. 3A is a schematic plan view of one embodiment of a liquid spraying structure with a magnetization device;

FIG. 3B is a schematic diagram of magnetic lines of force in one embodiment of the liquid spraying structure with a magnetization device;

FIG. 4A is a schematic plan view of another embodiment of a liquid spraying structure with a magnetization device;

FIG. 4B is a schematic diagram of magnetic lines of force in another embodiment of the liquid spraying structure with a magnetization device.

FIG. 5A is a schematic plan view of another embodiment of a liquid spraying structure with a magnetization device;

FIG. 5B is a schematic diagram of magnetic lines of force of another embodiment of the liquid spraying structure with a magnetization device;

FIG. 6A is a schematic plan view of another embodiment of a liquid spraying structure with a magnetization device; and

FIG. 6B is a schematic diagram of magnetic lines of force of another embodiment of the liquid spraying structure with a magnetization device.

### DETAILED DESCRIPTION

The present invention will be clearer from the following description when viewed together with the accompanying drawings, which show, for purpose of illustrations only, the preferred embodiment in accordance with the present invention.

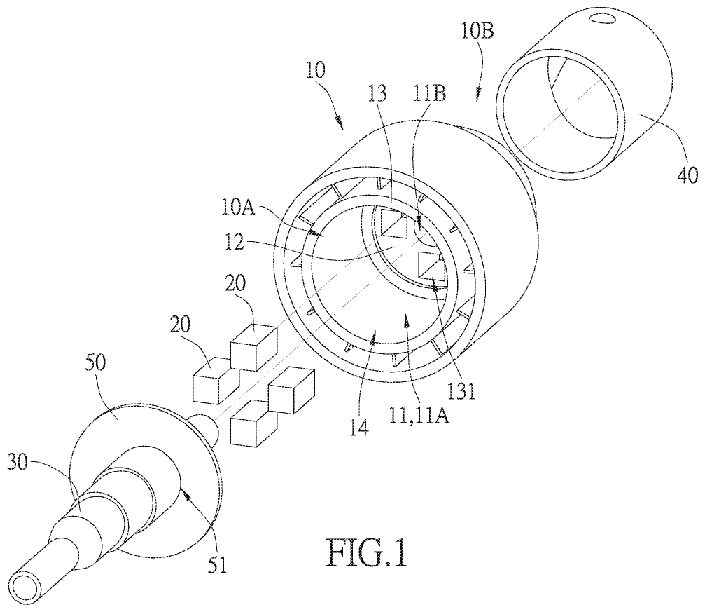

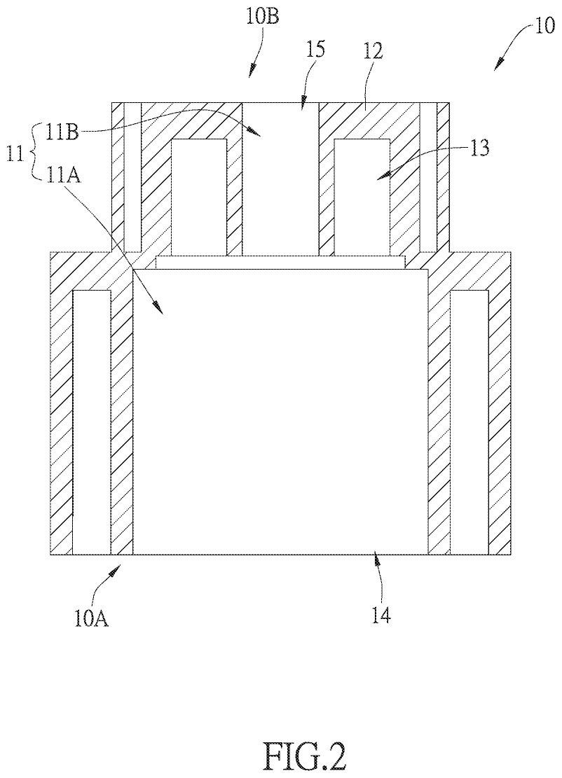

Referring to FIGS. 1-3B, a liquid spraying structure with a magnetization device in accordance with the first embodiment of the present invention comprises: a body 10, a plurality of magnetic members 20, a pump unit 30, and a spray head 40.

The body 10 has a through hole 11, and around the through hole 11 there is a magnetic member accommodating portion 12 which has at least two magnetic member accommodating grooves 13 which are symmetrical in position.

In a preferred embodiment, the through hole 11 penetrates a first end 10A and a second end 10B of the body 10 such that the first end 10A has a first opening 14 and the second end 10B has a second opening 15. The through hole 11 is a stepped hole and formed by a first section 11A and a second section 11B which are connected to each other, the diameter of the first section 11A is larger than that of the second section 11B, the first section 11A is connected to the first opening 14, and the second section 11B is connected to the second opening 15. In a preferred embodiment, the first opening 14 and the second opening 15 have different diameters, and the second section 11B is surrounded by the magnetic member accommodating portion 12, the magnetic member accommodating portion 12 has at least two magnetic member accommodating grooves 13, and the positions of the magnetic member accommodating grooves 13 are symmetrical.

Preferably, the body 10 is provided on a side wall around the first section 11A with a thread for engaging with a thread at a mouth of a bottle.

The plurality of magnetic members 20 are disposed in the magnetic member accommodating grooves 13.

The pump unit 30 penetrates through the through hole 11 and is used to draw the liquid out of the bottle. In this embodiment, the pump unit 30 is an elongated cylindrical body, and includes a spring, a steel ball, a piston, a piston rod and other components. Since the structure of the pump unit 30 is conventional, it will not be described in detail.

Preferably, this embodiment further includes a sheet member 50 with a hole 51 in the center and is sleeved on the pump unit 30. The pump unit 30 inserts through the hole 51 to make the sheet member 50 seals the second section 11A to separate the first section 11A and the second section 11B. The sheet member 50 covers an opening 131 of each of the magnetic member accommodating grooves 13 to prevent the magnetic members 20 from falling out of the magnetic member accommodating grooves 13.

The spray head 40 is connected to one end of the pump unit 30, and the pump unit 30 is used to transport the liquid in the bottle to the spray head 40, and then the spray head 40 discharges the liquid.

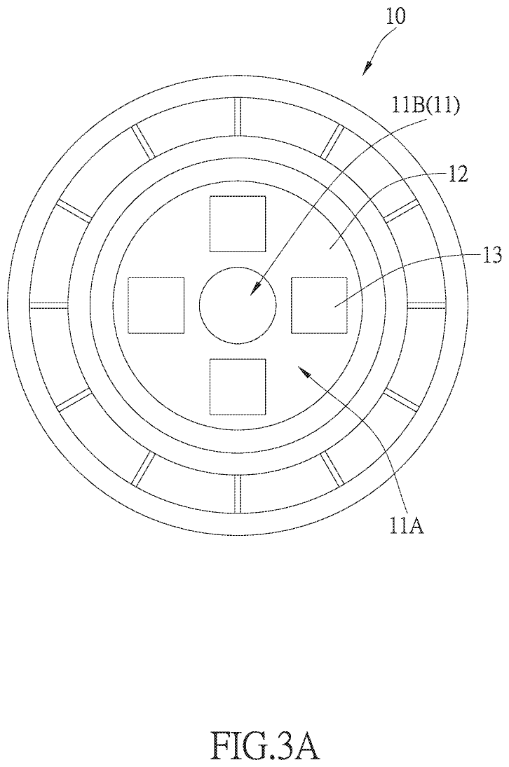

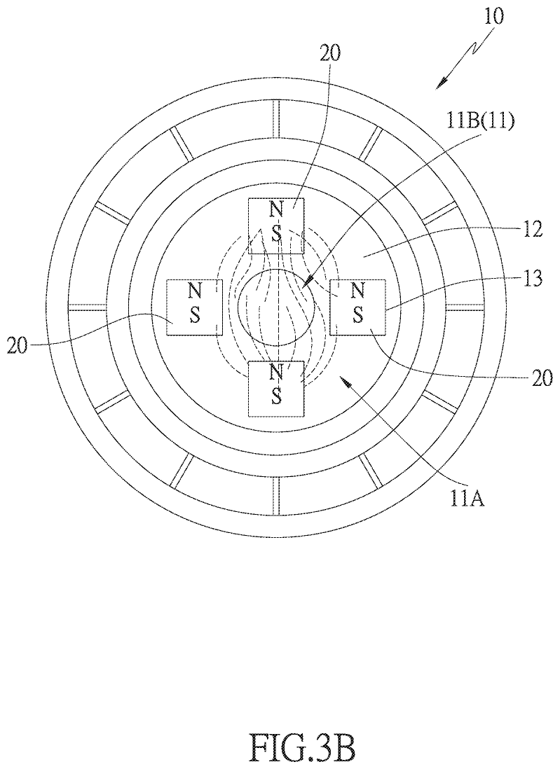

In the first embodiment of the present invention, please refer to FIGS. 3A and 3B, the number of the magnetic member accommodating grooves 13 is four, and the four magnetic member accommodating grooves 13 are equally spaced around the through hole 11, therefore, two of the magnetic member accommodating grooves 13 are located on two opposite sides of the through hole 11, the other two magnetic member accommodating grooves 13 are located on the other two opposite sides of the through hole 11. The magnetic direction of each of the magnetic members 20 is the same. Magnetic lines of force of two of the magnetic members 20 pass through the through hole 11, and the other two of the magnetic members 20 are provided to avoid magnetic field leakage.

In a specific embodiment, each of the magnetic member accommodating grooves 13 is a rectangular groove, and each of the magnetic members 20 is rectangular; in another embodiment, each of the magnetic member accommodating grooves 13 is circular, and each magnetic member 20 is cylindrical.

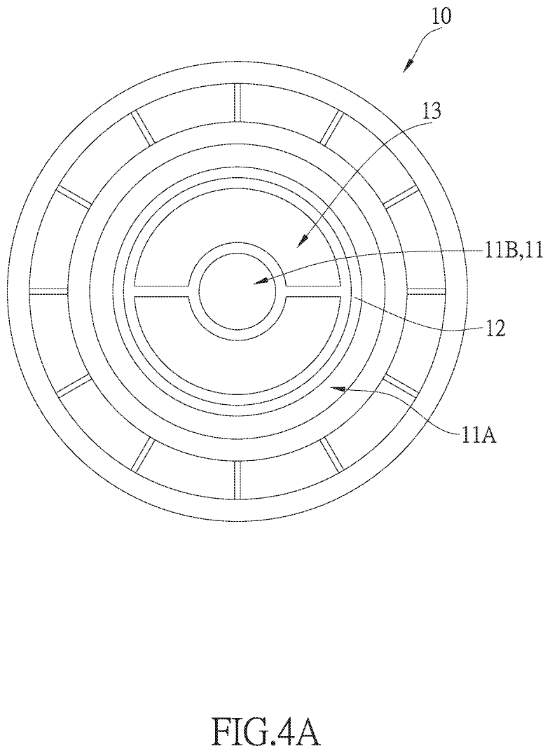

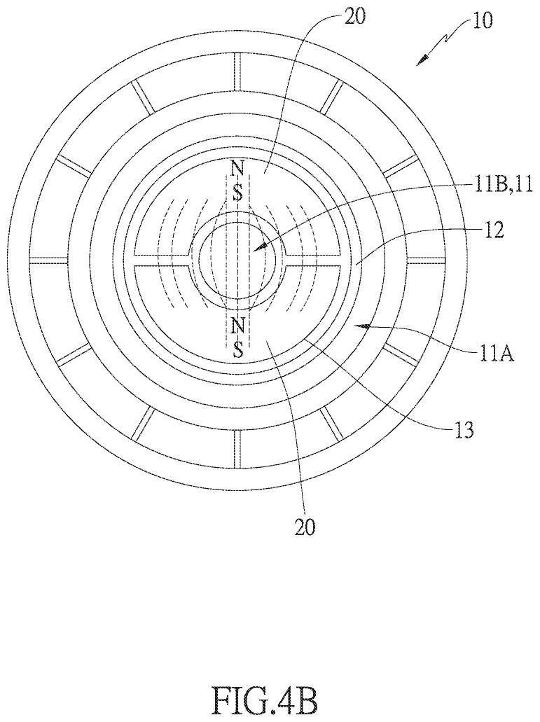

In the second embodiment of this invention, please refer to FIGS. 4A and 4B, the number of the magnetic member accommodating grooves 13 is two, the two magnetic member accommodating grooves 13 are located on two opposite sides of the through hole 11, and each have a semi-annular shape. The two magnetic member accommodating grooves 13 surround the through hole 11, each of the two magnetic members 20 is a semi-annular cylinder, and the two magnetic members 20 have the same magnetic direction, so that the magnetic lines of force pass through the through hole 11.

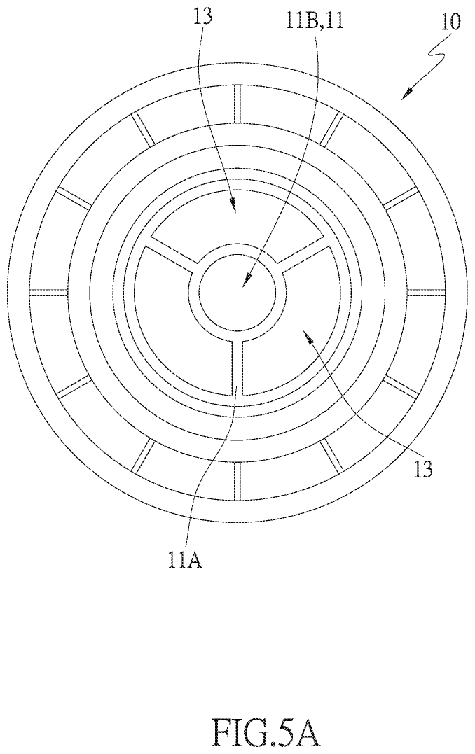

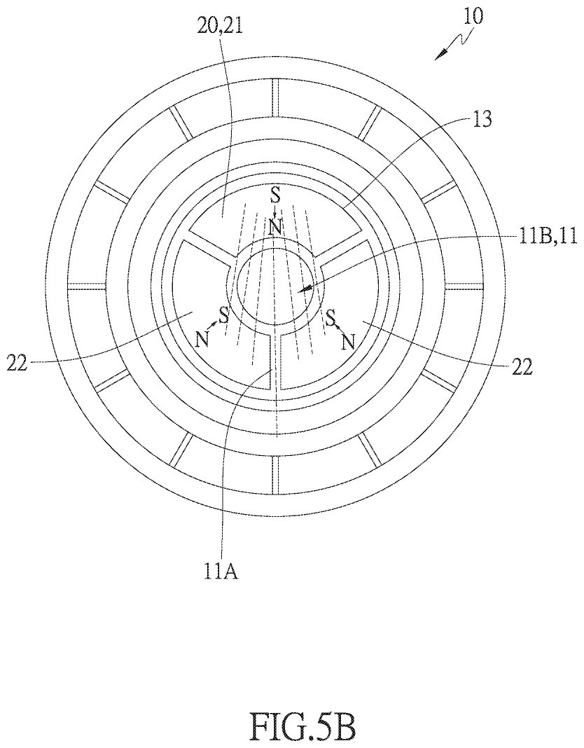

In the third embodiment of this invention, please refer to FIGS. 5A and 5B, the number of the magnetic member accommodating grooves 13 is three, the magnetic member accommodating grooves 13 are arc-shaped and distributed at equal intervals around the through hole 11, so that the three magnetic member accommodating grooves 13 surround the through hole 11. The number of the magnetic members 20 is three, one of the magnetic members 20 is a first-direction magnet 21, the other two magnetic members 20 are second-direction magnets 22, and the magnetic direction of the first-direction magnet 21 is opposite to the magnetic directions of the two second-direction magnets 22, so that the magnetic lines of force the three magnetic members 20 pass through the through hole 11. In one embodiment, please refer to FIG. 5B, the magnetic direction of the first-direction magnet 21 is toward the through hole 11, and the magnetic directions of the two second-direction magnets 22 are away from the through hole 11. In another embodiment, the magnetic direction of the first-direction magnet 21 is away from the through hole 11, and the magnetic directions of the two second-direction magnets 22 are toward the through hole 11.

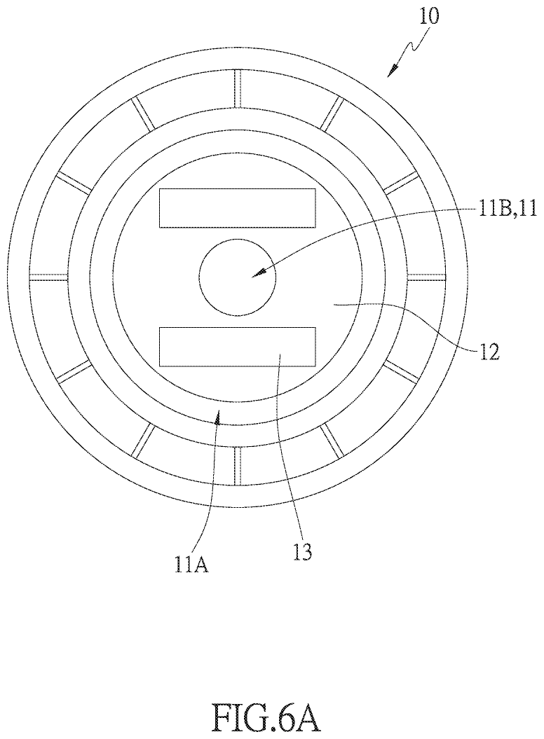

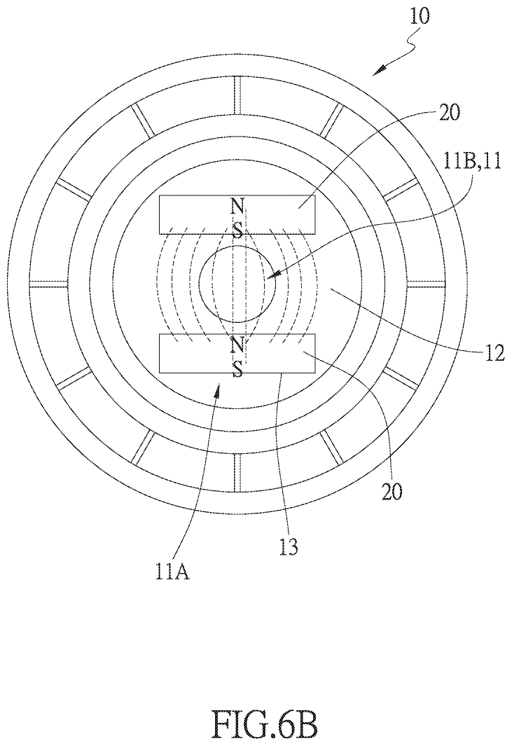

In the fourth embodiment of this invention, please refer to FIGS. 6A and 6B, the number of the magnetic member accommodating grooves 13 is two, and the two magnetic member accommodating grooves 13 are located on two opposite sides of the through hole 11, and each have a rectangular shape. Each of the two magnetic members 20 has a rectangular shape, and the two magnetic members 20 have the same magnetic direction, so that the magnetic lines of force of the two magnetic members 20 pass through the through hole 11.

In the present invention, the magnetic members 20 are fixed in the magnetic member accommodating grooves 13, so that the magnetic members 20 can be fixed around the pump unit 30 without being displaced by the influence of magnetic force.

While we have shown and described various embodiments in accordance with the present invention, it is clear to those skilled in the art that further embodiments may be made without departing from the scope of the present invention.

What is claimed is:

1. A liquid spraying structure with a magnetization device comprising:
a body having a through hole and a magnetic member accommodating portion around the through hole, the magnetic member accommodating portion having at least two magnetic member accommodating grooves;
a plurality of magnetic members disposed in the at least two magnetic member accommodating grooves;
a pump unit penetrating through the through hole and being used to draw liquid out of a bottle; and
a spray head connected to one end of the pump unit, and the pump unit is used to transport the liquid in the bottle to the spray head.

2. The liquid spraying structure with the magnetization device as claimed in claim 1, wherein the at least two magnetic member accommodating grooves are symmetrical in position.

3. The liquid spraying structure with the magnetization device as claimed in claim 1, wherein the through hole penetrates a first end and a second end of the body such that the first end has a first opening and the second end has a second opening, the through hole is a stepped hole and formed by a first section and a second section which are connected to each other, a diameter of the first section is larger than that of the second section, the first section is connected to the first opening, and the second section is connected to the second opening.

4. The liquid spraying structure with the magnetization device as claimed in claim 3, wherein the first opening and the second opening have different diameters, and the second section is surrounded by the magnetic member accommodating portion.

5. The liquid spraying structure with the magnetization device as claimed in claim 1, wherein the number of the magnetic member accommodating grooves is four, the four magnetic member accommodating grooves are equally spaced around the through hole, two of the magnetic member accommodating grooves are located on two opposite sides of the through hole, another two magnetic member accommodating grooves are located on another two opposite sides of the through hole, and the number of the magnetic members is four.

6. The liquid spraying structure with the magnetization device as claimed in claim 5, wherein the four magnetic members have the same magnetic direction.

7. The liquid spraying structure with the magnetization device as claimed in claim 1, wherein the number of the magnetic member accommodating grooves is two, two said magnetic member accommodating grooves are located on two opposite sides of the through hole and each have a semi-annular shape, and the two magnetic member accommodating grooves surround the through hole, each of the two magnetic members is a semi-annular cylinder.

8. The liquid spraying structure with the magnetization device as claimed in claim 7, wherein the two magnetic members have the same magnetic direction.

9. The liquid spraying structure with the magnetization device as claimed in claim 1, wherein the number of the magnetic member accommodating grooves is three, the number of the magnetic members is three, the magnetic member accommodating grooves are arc-shaped and distributed at equal intervals around the through hole.

10. The liquid spraying structure with the magnetization device as claimed in claim 9, wherein one of the magnetic members is a first-direction magnet, the other two magnetic members are second-direction magnets, and a magnetic direction of the first-direction magnet is opposite to magnetic directions of the two second-direction magnets.

11. The liquid spraying structure with the magnetization device as claimed in claim 1, wherein the number of the magnetic member accommodating grooves is two, the two magnetic member accommodating grooves are located on two opposite sides of the through hole and each have a rectangular shape, and each of the magnetic members has a rectangular shape.

12. The liquid spraying structure with the magnetization device as claimed in claim 11, wherein the two magnetic members have the same magnetic direction.
